(19) United States
(12) Patent Application Publication
(10) Pub. No.: US 2020/0404599 A1
(43) Pub. Date: Dec. 24, 2020

(54) FEMTOCELL BASE STATION SYNCHRONIZATION

(71) Applicant: Intel Corporation, Santa Clara, CA (US)

(72) Inventor: Nicholas William Whinnett, Wiltshire (GB)

(21) Appl. No.: 16/806,461

(22) Filed: Mar. 2, 2020

Related U.S. Application Data
(63) Continuation of application No. 13/531,293, filed on Jun. 22, 2012, now abandoned.

(51) Int. Cl. H04W 56/00

(52) U.S. Cl. CPC H04W 56/001

(57) ABSTRACT

There is provided a method of determining a timing estimate for use in synchronizing a femtocell base station to a macrocell base station, the method in the femtocell base station comprising determining an uplink timing estimate from a signal transmitted from a mobile device to the macrocell base station, the mobile device being served by the macrocell base station; determining a downlink timing estimate from a signal transmitted from the macrocell base station; and determining a timing estimate for use in synchronizing the femtocell base station to the macrocell base station from the downlink timing estimate and the uplink timing estimate.

### 1. FIELD OF THE INVENTION

The invention relates to the synchronization of a femtocell base station to a macrocell base station, and in particular relates to a method for estimating or accounting for the propagation delay between a femtocell base station and a macrocell base station in a synchronization process, and a femtocell base station configured to perform the method.

### 2. BACKGROUND TO THE INVENTION

Femtocell base stations in a Long Term Evolution (LTE) communication network (otherwise known as Home evolved Node Bs—HeNBs—or Enterprise evolved Node Bs—EeNBs) are small, low-power, indoor cellular base stations for residential or business use. They provide better network coverage and capacity than that available in such environments from the overlying macrocellular LTE network. Femtocell base stations use a broadband connection to receive data from and send data back to the operator's network (known as “backhaul”).

Base stations (whether for femtocells, picocells, macrocells, etc.) in an LTE communication network can support frequency division duplexing (FDD) and time division duplexing (TDD). TDD base stations use a carrier at a single frequency for uplink and downlink communications by partitioning the carrier in time between the uplink (UL) and downlink (DL).

In communication networks where multiple TDD base stations use a carrier at the same frequency, it is necessary to time synchronize the base stations to prevent the uplink and downlink transmissions from the base stations overlapping in time, which causes interference. This problem is illustrated in FIG. 1 for two macrocell base stations.

FIG. 1 shows first and second TDD macrocell base stations 2, 4 having respective coverage areas indicated by macrocell 6, 8. In an LTE communication network, the macrocell base stations are referred to as evolved Node Bs (eNBs).

A first user equipment (UE) 10 is located in the coverage area of the first macrocell base station 2, close to the edge of the macrocell area 6. The first UE 10 is being served by the first macrocell base station 2 (so it is referred to as a macro UE, or mUE) which means that it transmits and/or receives control signaling and/or data using the macrocell base station 2. Due to the location of the first UE 10 at the edge of the first macrocell 6, the first UE 10 receives weak downlink signals 12 from the first macrocell base station 2.

A second UE 14 is located in the coverage area of the second macrocell base station 4, but close to the edge of the macrocell area 8. The second UE 14 is being served by the second macrocell base station 4. The second UE 14 is also located close to the first UE 10.

Assuming that the first and second macrocell base stations 2, 4 are using the same frequency carrier, uplink signals 16 from the second UE 14 to the second macrocell base station 4 may cause significant interference at the nearby first UE 10 if the first and second macrocell base stations 2, 4 are not time synchronized.

A similar problem exists for a femtocell base station located within the coverage area of a macrocell base station, so time synchronization is required if a femtocell base station and macrocell base station share a carrier frequency. This synchronization can prevent interference for a macro UE receiving a downlink signal from the macrocell base station from uplink signals being transmitted by a nearby femto UE (i.e. a UE being served by the femtocell base station).

In a conventional LTE network, a femtocell base station can synchronize with a macrocell base station as follows. Firstly, the femtocell base station detects a Primary Synchronization Sequence transmitted by the macrocell base station, which allows the femtocell base station to obtain the orthogonal frequency-division multiplexing (OFDM) symbol timing of the macrocell base station and a frequency offset between the femtocell base station and macrocell base station.

Next, the femtocell base station detects a Secondary Synchronization Sequence transmitted by the macrocell base station, from which the femtocell base station determines the frame timing (i.e. the timing of the 10 ms frames) of the transmissions from the macrocell base station.

The femtocell base station can then refine the frequency offset measurement by measuring downlink reference symbols transmitted by the macrocell base station.

The frequency of a clock maintained in the femtocell base station is then adjusted based on the refined frequency offset and the symbol and frame timing of transmissions from the femtocell base station are adjusted to align with the transmissions by the macrocell base station.

This process can be periodically repeated by the femtocell base station.

3GPP RAN4 have agreed a specification on TDD femtocell timing accuracy for LTE (TS 36.133 v10.1.0 section 7.4.2). The specification indicates that the timing of transmissions in a femtocell should be synchronized with those in an overlying macrocell to within 3 μs.

If the femtocell base station obtains its synchronization by locking on to (or “sniffing”) synchronization information transmitted by a macrocell base station in a downlink as described above then the 3 μs accuracy requirement holds for up to 500 m separation between the femtocell base station and the macrocell base station.

The one-way propagation delay between the macrocell base station and the femtocell base station with a separation of 500 m is approximately 1.6 μs. As well as this propagation delay, the signal from the macrocell base station is subject to scattering due to reflection off objects (buildings, etc.) such that multiple delayed versions (or echoes) of the signal from the macrocell base station will be received at the femtocell base station. This is known as multipath propagation and results in a multipath “delay spread” (which is the time between the earliest received version and the last detectable echo of the signal). This multipath delay spread can be of the order of 0.5 μs and leads to timing uncertainty.

Thus, in a typical femtocell base station/macrocell base station arrangement, the propagation delay plus delay spread uncertainty could be of the order of 2 μs, which means that the hardware in femtocell base station has to be accurate to approximately 1 μs to meet the 3 μs accuracy requirement. Building hardware with this accuracy requires significant effort and complexity to achieve.

Therefore, there is a need for a way to determine a timing estimate for use in synchronizing the femtocell base station to the macrocell base station that accounts for the propagation delay between the femtocell base station and the macrocell base station, thereby easing the accuracy requirements on the femtocell base station hardware.

### SUMMARY OF THE INVENTION

According to a first aspect of the invention, there is provided a method of determining a timing estimate for use in synchronizing a femtocell base station to a macrocell base station, the method in the femtocell base station comprising determining an uplink timing estimate from a signal transmitted from a mobile device to the macrocell base station, the mobile device being served by the macrocell base station; determining a downlink timing estimate from a signal transmitted from the macrocell base station; and determining a timing estimate for use in synchronizing the femtocell base station to the macrocell base station from the downlink timing estimate and the uplink timing estimate.

In a preferred embodiment, the signal transmitted from the mobile device to the macrocell base station comprises a plurality of symbols, each symbol having a cyclic prefix, and the step of determining an uplink timing estimate from the signal transmitted from the mobile device to the macrocell base station comprises determining an uplink symbol timing estimate by examining the signal and identifying repeated portions in the signal, the repeated portions being a cyclic prefix at the start of a symbol and a final portion of the symbol corresponding to the cyclic prefix; and determining the uplink symbol timing estimate as the start of the identified cyclic prefix.

Preferably, the step of determining a downlink timing estimate from the signal transmitted from the macrocell base station comprises determining a downlink symbol timing estimate from synchronization information contained in the signal.

In some embodiments, the method in the femtocell base station further comprises the step of determining an offset between uplink and downlink transmissions between the macrocell base station and the mobile device; and the timing estimate for use in synchronizing the femtocell base station to the macrocell base station is determined from the offset, the downlink timing estimate and/or the uplink timing estimate.

In some embodiments, the method in the femtocell base station further comprises the step of identifying a mobile device that is being served by the macrocell base station and that is near to the femtocell base station; and the step of determining an uplink timing estimate comprises determining the uplink timing estimate from a signal transmitted to the macrocell base station by the identified mobile device.

In these embodiments, the step of identifying a mobile device that is near to the femtocell base station preferably comprises receiving signals at the femtocell base station transmitted by a mobile device that is being served by the macrocell base station; comparing the strength of the signals received at the femtocell base station to a threshold; and determining that the mobile device is close to the femtocell base station if the strength of the signals exceeds the threshold.

In some embodiments, the method in the femtocell base station further comprises the step of causing a mobile device that is being served by the femtocell base station to hand-off to the macrocell base station; and the step of determining an uplink timing estimate comprises determining the uplink timing estimate from a signal transmitted to the macrocell base station by that mobile device.

In some embodiments, the timing estimate determined in the step of determining a timing estimate for use in synchronizing the femtocell base station to the macrocell base station is an estimate of the propagation delay between the macrocell base station and the femtocell base station.

Preferably, the estimate of the propagation delay is determined from the difference between the downlink timing estimate and the uplink timing estimate.

In alternative embodiments, the timing estimate determined in the step of determining a timing estimate for use in synchronizing the femtocell base station to the macrocell base station is an estimate of the symbol timing at the macrocell base station.

Preferably, the estimate of the symbol timing at the macrocell base station is determined by (i) taking the average of the downlink timing estimate and the uplink timing estimate; (ii) estimating the propagation delay between the macrocell base station and the femtocell base station from the difference between the downlink timing estimate and the uplink timing estimate and subtracting the estimated propagation delay from the downlink timing estimate; or (iii) estimating the propagation delay between the macrocell base station and the femtocell base station from the difference between the downlink timing estimate and the uplink timing estimate and adding the estimated propagation delay to the uplink timing estimate.

According to a second aspect of the invention, there is provided a method of synchronizing a femtocell base station to a macrocell base station, the method comprising determining a timing estimate as described above and adjusting the timing of transmissions from the femtocell base station according to the determined timing estimate.

According to a third aspect of the invention, there is provided a computer program product comprising computer-readable code embodied therein, the computer-readable code being configured to cause a computer or processor to perform the methods described in the preceding paragraphs.

According to a fourth aspect of the invention, there is provided a femtocell base station for use in a communication network comprising at least one macrocell base station, the femtocell base station comprising a processor configured to determine a timing estimate for use in synchronizing the femtocell base station to the macrocell base station by determining an uplink timing estimate from a signal transmitted from a mobile device to the macrocell base station, the mobile device being served by the macrocell base station; determining a downlink timing estimate from a signal transmitted from the macrocell base station; and determining a timing estimate for use in synchronizing the femtocell base station to the macrocell base station from the downlink timing estimate and the uplink timing estimate.

Particular embodiments of the femtocell base station provide that the processor can be configured to perform the steps in the method described in the above paragraphs.

### BRIEF DESCRIPTION OF THE DRAWINGS

Embodiments of the invention will now be described in detail, by way of example only, with reference to the following drawings, in which:

FIG. 1 shows a macrocellular communication network;

FIG. 2 shows an exemplary communication network including a femtocell base station in which the invention can be implemented;

FIG. 3 is a block diagram of a femtocell base station in accordance with the invention;

FIG. 4 is a simplified illustration of the communication network 22 shown in FIG. 2;

FIG. 5 is a flow chart illustrating a method of determining a timing estimate according to the invention;

FIG. 6 is an illustration of an uplink signal from a macro UE to a macrocell base station; and

FIG. 7 is an illustration of the relative timing of signals transmitted between a macro UE and a macrocell base station.

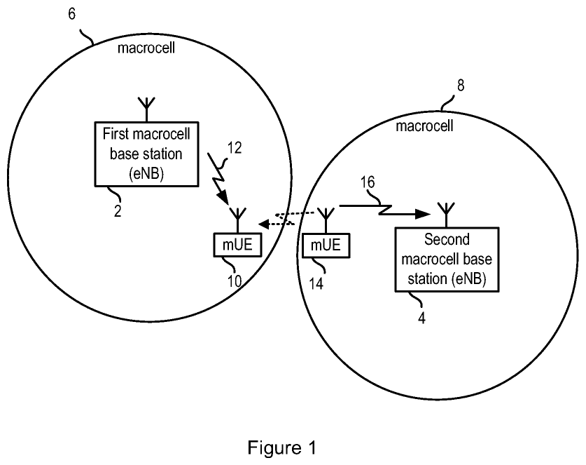

### DETAILED DESCRIPTION OF THE PREFERRED EMBODIMENTS

Although the invention will be described below with reference to an LTE communication network and femtocell base stations or HeNBs, it will be appreciated that the invention is applicable to any type of second, third or subsequent generation network in which femtocell base stations (whether for home, business or public use), or their equivalents in those networks, can be deployed, such as TD-SCDMA, WiMAX and WCDMA/HSPA, and where the femtocell base station is required to time synchronize with a macrocell base station. Moreover, although in the embodiments below the femtocell base stations and macrocell base stations use the same air interface (LTE), it will be appreciated that the invention can be used in a situation in which the macrocell and femtocell base stations use different air interface schemes (for example the macrocell base stations could use TD-SCDMA or WCDMA while the femtocell base stations use LTE).

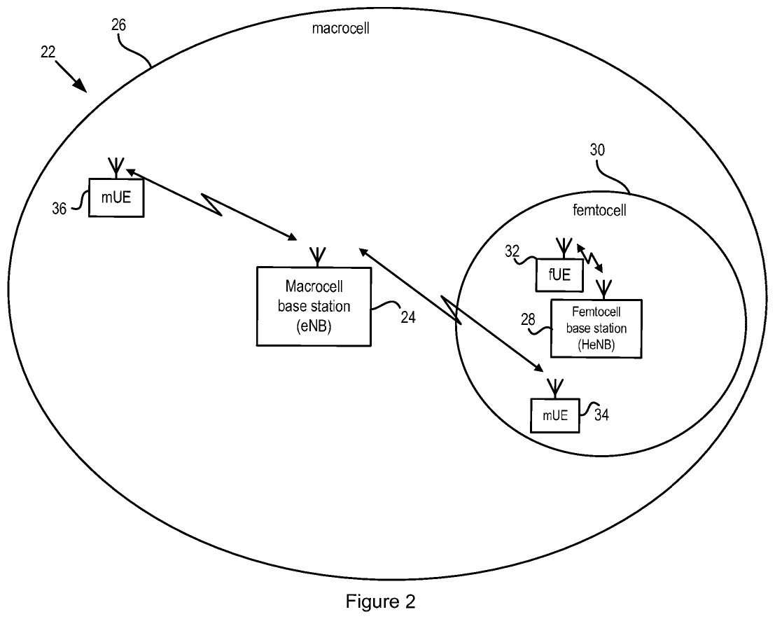

FIG. 2 shows part of an exemplary communication network 22 in which the invention can be implemented. The communication network 22 includes a plurality of macrocell base stations 24 (only one of which is shown in FIG. 2) that each define a respective coverage area indicated by macrocell 26. As indicated above, in an LTE communication network, the macrocell base stations 24 are referred to as evolved Node Bs (eNBs).

One or more femtocell base stations 28 (Home eNBs—HeNBs) can be located within the coverage area 26 of the macrocell base station 24 (although only one femtocell base station 28 is shown in FIG. 2), with each femtocell base station 28 defining a respective coverage area indicated by femtocell 30.

It will be appreciated that FIG. 2 has not been drawn to scale, and that in most real-world implementations the coverage area 30 of the femtocell base station 28 will be significantly smaller than the coverage area 26 of the macrocell base station 24.

A number of mobile devices (user equipments—UEs) 32, 34 and 36 are also located in the communication network 22 within the coverage area 26 of the macrocell base station 24.

Mobile device 32 is located within the coverage area 30 of the femtocell base station 28 and is currently being served by the femtocell base station 28, meaning that it transmits and/or receives control signaling and/or data using the femtocell base station 28. Mobile devices served by femtocell base stations are referred to as femto UEs herein.

Mobile devices 34 and 36 are each currently being served by the macrocell base station 24 (i.e. they are macro UEs), meaning that they transmit and/or receive control signaling and/or data using the macrocell base station 24. In the figure, mobile device 34 is shown as being within the coverage area 30 of the femtocell base station 28, and is therefore quite close to femto UE 32 (since the femtocell 30 covers a relatively small area), although it will be appreciated that mobile device 34 could be located outside the coverage area 30 of the femtocell base station 28 but still quite close to femto UE 32.

When the macrocell base station 24 and femtocell base station 28 use the same or a common frequency carrier, it is necessary to synchronize the femtocell base station 28 with the macrocell base station 24 to avoid interference to downlink transmissions to macro UE 34 by uplink transmissions from the femto UE 32, or to downlink transmissions to the femto UE 32 by uplink transmissions from the macro UE 34.

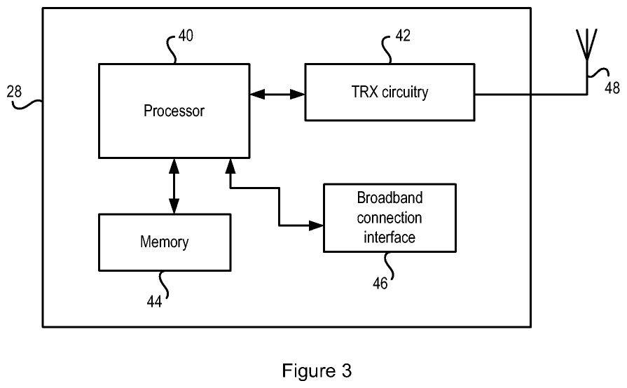

The femtocell base station 28 is illustrated in more detail in FIG. 3. The femtocell base station 28 comprises a processor 40 that controls the operation of the femtocell base station 28, transceiver circuitry 42, memory 44 and broadband connection interface 46 that are each connected to the processor 40, and an antenna 48 connected to the transceiver circuitry 42.

One function of the processor 40 is to maintain a clock or timer that is used, for example, to determine the appropriate times for transmitting and receiving signals over the air interface. During conventional synchronization with a nearby macrocell base station 24, a timing value and frequency offset is determined that is applied to the clock of the femtocell base station 24 in order for the femtocell base station 28 to be time and frequency synchronized with the macrocell base station 24.

As described above, although the existing time synchronization method allows the femtocell base station 28 to determine a timing value from synchronization information contained in signals from the macrocell base station 24, no effort is made to estimate or account for the propagation delay between the femtocell base station and the macrocell base station, with the result that there is an increased accuracy burden on the hardware of the femtocell base station.

Thus, the invention provides a method for the femtocell base station to determine a timing estimate for use in synchronizing a femtocell base station to a macrocell base station.

In one embodiment, the timing estimate is the propagation delay. The estimated propagation delay can then be used in a process in which the femtocell base station 28 synchronizes with the macrocell base station 24, thereby relaxing the timing accuracy required of the clock (or timer) and other hardware in the femtocell base station. In particular, a signal timing estimated by the femtocell base station 28 from observing signals received from the macrocell base station 24 can be ‘advanced’ by an amount equal to the estimated propagation delay, thereby removing the effect of the propagation delay.

In an alternative embodiment, the femtocell base station 28 can determine an estimate of the symbol timing at the macrocell base station 24 (which does not include the propagation delay), and this timing estimate is used to synchronize the femtocell base station 28 to the macrocell base station 24.

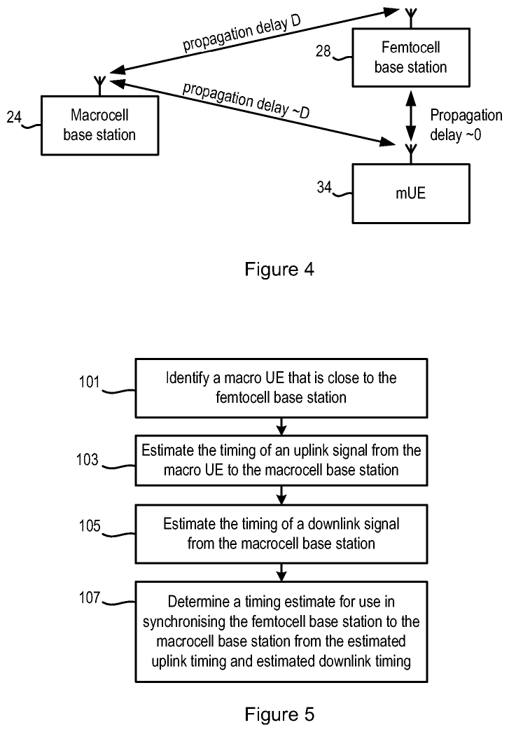

FIG. 4 is a simplified illustration of the communication network 22 shown in FIG. 2. In particular, FIG. 4 shows the macrocell base station 24, femtocell base station 28 and macro UE 34, which is within the coverage area of, or otherwise close to, the femtocell base station 28. The propagation delay between the femtocell base station 28 and the macrocell base station 24 that is to be estimated is denoted D.

Due to the proximity of macro UE 34 to the femtocell base station 28, two approximations can be made; the first is that the propagation delay between macro UE 34 and the femtocell base station 28 is zero, and the second is that the propagation delay between the macro UE 34 and the macrocell base station 24 is the same as the propagation delay between the femtocell base station 28 and macrocell base station 24 (i.e. D). Therefore, according to the invention, the femtocell base station 28 estimates the propagation delay D by estimating the propagation delay between the macrocell base station 24 and macro UE 34.

In macrocellular networks, macro UEs have their timing controlled by their serving macrocell base station via the control of a “timing advance” value. This timing advance value, denoted t_{adv} herein, is used by the macro UE to advance their transmissions in time by an amount that means signals transmitted from the macro UE reach the macrocell base station at a designated time. Different macro UEs have respective timing advance values based on their distance from the macrocell base station, such that macro UEs further from the macrocell base station will start their uplink transmissions earlier so that all macro UE transmissions arrive at the macrocell base station at roughly the same time.

A method of determining a timing estimate for use in synchronizing the femtocell base station 28 to the macrocell base station 24 according to the invention is shown in FIG. 5.

Firstly (step 101), the femtocell base station 28 identifies a macro UE 34 that is close to the femtocell base station 24. A macro UE can be deemed to be close to a femtocell base station if the propagation loss and propagation delay there between are both low (i.e. negligible when compared to, or an order of magnitude less than, the propagation loss and propagation delay between the femtocell base station and the macrocell base station). In a particular embodiment, the femtocell base station 28 determines the strengths of signals received from any macro UEs in the surrounding area (which is not restricted to the femtocell area 30), and identifies a macro UE 34 that is close to the femtocell base station 28 as a macro UE 34 with a received signal strength that is above a threshold value. This threshold value is set so that it ensures that the macro UE 34 is sufficiently close to the femtocell base station 28 that the propagation delay there between can be approximated to zero. The threshold value can be −70 to −50 dBm per Resource Block (one Resource Block in LTE is 180 kHz), which would mean that the distance between the macro UE 34 and femtocell base station 28 should not exceed 50 m.

Once a macro UE 34 that is close to the femtocell base station 28 has been identified, the femtocell base station 28 estimates the timing of an uplink signal from the macro UE 34 to the macrocell base station 24 (step 103). The femtocell base station 28 can estimate this timing by exploiting known properties of the uplink signal.

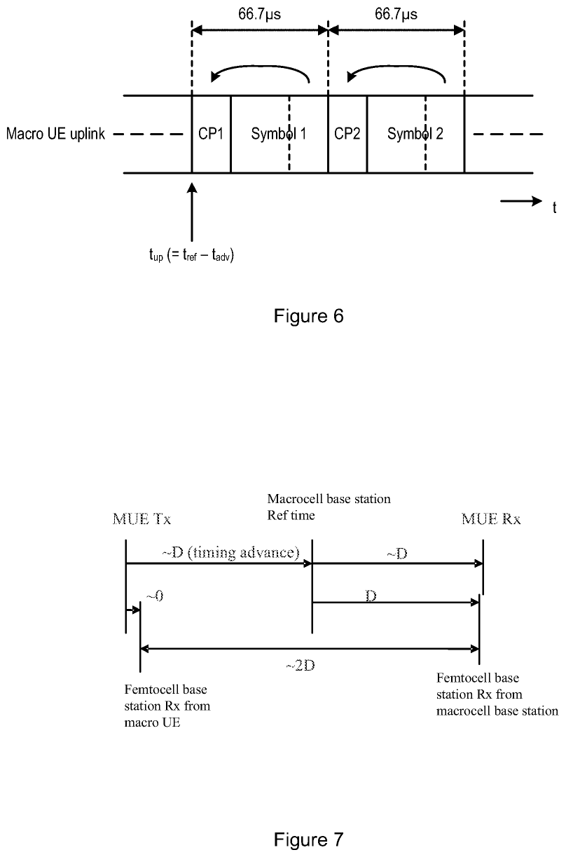

In LTE, there are 14 symbols per 1 ms subframe and each symbol starts with a cyclic prefix that is a copy of a final portion of the symbol. Part of a macro UE uplink transmission is illustrated in FIG. 6, with the cyclic prefix of Symbol 1 being denoted CP1 and the cyclic prefix of Symbol 2 being denoted CP2.

In a preferred embodiment, the femtocell base station 28 estimates a symbol timing in the macro UE 34 uplink by finding the position of a cyclic prefix at the start of a data symbol. In particular, the femtocell base station 28 examines the received uplink signal and identifies portions that are repeated (e.g. CP1 is a repeat of the portion at the end of Symbol 1). The symbol timing can be estimated as the start of an identified cyclic prefix at the start of the symbol. Preferably, the estimate of the symbol timing is made relative to the symbol/frame timing currently used by the femtocell base station 28.

The timing of the start of a symbol estimated from the macro UE 34 uplink is denoted tᵤₚ, as shown in FIG. 6. It will be appreciated that, due to the timing advance applied by the macro UE 34 to its transmissions based on the propagation delay between it and the macrocell base station 24, the time tᵤₚ will be ahead of the symbol timing in the macrocell base station t_{adv}.

In step 105, the femtocell base station 28 estimates the timing of a downlink signal from the macrocell base station 24 to the macro UE 34, again preferably relative to the symbol/frame timing currently used by the femtocell base station 28.

In one embodiment, the femtocell base station 28 estimates the timing of a downlink signal, denoted t_{down}, and specifically the symbol timing of the downlink signal, by detecting synchronization information transmitted by the macrocell base station 24. In LTE, this synchronization information is the Primary Synchronization Sequence. The estimation can be performed in the same way as in the conventional femtocell-macrocell synchronization process. Due to the propagation delay between the macrocell base station 24 and the femtocell base station 28, the estimated time t_{down} will differ from the symbol timing in the macrocell base station by D.

The macrocell uplink and downlink signals observed by the femtocell base station 28 described above are illustrated in FIG. 7. Thus, it can be seen that as a result of the effect of the timing advance in the uplink signal and propagation delay in the downlink signal, the uplink and downlink symbol timing estimates obtained by the femtocell base station 28 will differ by approximately twice the propagation delay D. In particular, the symbol timing of the downlink signal will be 2D later than the symbol timing of the uplink signal.

Therefore, in step 107, the femtocell base station 28 determines the timing estimate from the estimated uplink timing and the estimated downlink timing.

In the embodiment where the femtocell base station 28 estimates the propagation delay D directly, the propagation delay D is determined as half the difference between the estimated downlink and uplink symbol timings.

Once the propagation delay D has been estimated as shown in FIG. 5, the femtocell base station 28 can apply the estimated propagation delay D to timing estimates obtained during a synchronization process with the macrocell base station 24 in order to improve the synchronicity of the femtocell base station 28 with the macrocell base station 24. This means that the timing accuracy required of the hardware in the femtocell base station 28 in order to meet the 3 μs accuracy requirement defined in the LTE standard.

In the alternative embodiment, in step 107, the femtocell base station 28 determines an estimate of the symbol timing at the macrocell base station 24 that is used for synchronizing the femtocell base station 28 to the macrocell base station 24 (the estimate of the symbol timing not including the propagation delay) as half of the sum of the uplink timing estimate and the downlink timing estimate.

As the communication network is a time-division duplex network, uplink and downlink transmissions occur in distinct time slots, and therefore there is a known offset between uplink and downlink transmissions in the macrocell. Therefore, the femtocell base station 28 can take this offset into account when determining the propagation delay or propagation-delay-adjusted timing estimate from the difference or sum of the uplink and downlink symbol timing estimates respectively. For example, in LTE TDD, the uplink timing is advanced by 20.3 μs, so the femtocell base station 28 will add this to the uplink timing estimate tᵤₚ to give t′ᵤₚ, and t′ᵤₚ is used with the downlink timing estimate to determine the propagation delay as described above.

It will be noted that as the propagation delays expected to exist between a femtocell base station and a macrocell base station are considerably smaller than the typical duration of a symbol in LTE (approximately 66.7 μs), it is not necessary for the femtocell base station 28 to determine exactly which symbol in the uplink subframe has been measured in step 103.

It will be appreciated that the steps in the method shown in FIG. 5 do not have to be performed in the recited order. In particular, in FIG. 5, step 105 can be performed prior to step 101 and/or step 103 without affecting the operation of the invention.

Those skilled in the art will also appreciate that it is not strictly necessary to perform the method according to the invention separately from a femtocell-macrocell synchronization process, and that in fact the method according to the invention can be implemented as an additional step in the femtocell-macrocell synchronization process.

For example, the conventional synchronization process described in the Background section can be modified as follows.

Firstly, the femtocell base station 28 can detect a Primary Synchronization Sequence transmitted by the macrocell base station 24, which allows the femtocell base station 28 to obtain the orthogonal frequency-division multiplexing (OFDM) symbol timing of the macrocell base station 24 and a frequency offset between the femtocell base station 28 and macrocell base station 24. This is similar to step 105 in FIG. 5.

Next, the femtocell base station 28 can detect a Secondary Synchronization Sequence transmitted by the macrocell base station 24, from which the femtocell base station 28 determines the frame timing (i.e. the timing of the 10 ms frames) of the transmissions from the macrocell base station 24.

The femtocell base station 28 can then identify a nearby macro UE 34 and estimate the symbol timing in an uplink from the macro UE 34 to the macrocell base station 24, as in steps 101 and 103 of FIG. 5.

In the conventional process, the symbol timing estimated from the Primary Synchronization Sequence is used as the symbol timing estimate. However, in a modified synchronization process according to a first embodiment of the invention, the femtocell base station 28 can determine the propagation delay as half of the difference between the downlink symbol timing estimated from the Primary Synchronization Sequence and the estimate of the uplink symbol timing (as described above with reference to step 107), with a correction to one or both of the estimates as appropriate based on the fixed and known offset between uplink and downlink transmissions. The femtocell base station 28 can then subtract this determined propagation delay from the downlink symbol timing estimate to give a refined estimate of the symbol timing. The propagation delay is also subtracted from the frame timing estimated from the Secondary Synchronization Sequence to give a refined frame timing estimate, since this frame timing estimate is also subject to the propagation delay.

Of course, it will be appreciated that the refined estimate of the symbol timing could instead be determined by adding the propagation delay to the uplink symbol estimate (since this approach is mathematically equivalent to determining the refined estimate of the symbol timing by subtracting the propagation delay (which is determined as half the difference between the uplink and downlink symbol timing estimates) from the downlink symbol timing estimate).

As in the conventional process, the femtocell base station 28 can then refine the frequency offset measurement by measuring downlink reference symbols transmitted by the macrocell base station 24 and adjust the frequency of a clock maintained in the femtocell base station 28 based on the measured and refined frequency offset.

The symbol and frame timing of transmissions from the femtocell base station 28 are then adjusted according to the refined symbol and frame timing estimates to align with the transmissions by the macrocell base station 24.

In a modified synchronization process according to the alternative embodiment of the invention, the femtocell base station 28 can determine the required symbol timing as half of the sum of the symbol timing estimate obtained using the Primary Synchronization Sequence and the uplink symbol timing estimate (as described above with reference to step 107), with a correction to one or both of the estimates as appropriate based on the fixed and known offset between uplink and downlink transmissions. The femtocell base station 28 can then adjust the symbol timing of its transmissions according to the determined symbol timing value.

Those skilled in the art will appreciate that the step of identifying a macro UE (step 101 in FIG. 5) may not result in the identification of a macro UE that is connected to the relevant macrocell base station 24 (i.e. the macrocell base station 24 to which the femtocell base station 28 is to synchronize), but instead one that is connected to another macrocell base station in the or another communication network. Alternatively, the femtocell base station 28 might not be able to identify a macro UE that is sufficiently close to allow the method to be performed.

In either case, the femtocell base station 24 may initiate the method according to the invention by forcing one of its femto UEs (e.g. femto UE 32 in FIG. 2) to hand-off to the required macrocell base station 24, and then measure the timing of the subsequent uplink transmissions from the UE to the macrocell base station 24. Thus, this means that the femtocell base station 28 can ensure that measurements are being made on an uplink to the correct macrocell base station 24 and that measurements can be made even where there are currently no macro UEs sufficiently close the femtocell base station 24.

It will be appreciated that, in the methods described above, where a step is described as being performed by the femtocell base station 28, the step would typically be performed by one or more of the components of the femtocell base station 28, such as the processor 40 and/or transceiver circuitry 42. Furthermore, where the invention is implemented as a series of computer readable instructions forming a computer program, the computer program can be stored in the memory 44 of the femtocell base station 28 and executed by the processor 40.

There is therefore provided a method for determining a timing estimate (particularly a propagation delay or a timing estimate adjusted for the propagation delay) for use in synchronizing a femtocell base station 28 to a macrocell base station 24, that can be used to ease the accuracy requirements on the femtocell base station hardware.

Finally, although the description above relates to the synchronization of TDD femtocell base stations to macrocell base stations, it will be appreciated that the method can also be used to synchronize FDD femtocell or picocell base stations to macrocell base stations, for example in the case of multicast transmissions, and references to a femtocell base station in the claims should be construed accordingly.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of determining a timing estimate for use in synchronizing a femtocell base station to a macrocell base station, the method in the femtocell base station comprising:
determining an uplink timing estimate from a signal transmitted from a mobile device to the macrocell base station, the mobile device being served by the macrocell base station;
determining a downlink timing estimate from a signal transmitted from the macrocell base station; and
determining a timing estimate for use in synchronizing the femtocell base station to the macrocell base station from the downlink timing estimate and the uplink timing estimate.

2. A method as claimed in claim 1, wherein the signal transmitted from the mobile device to the macrocell base station comprises a plurality of symbols, each symbol having a cyclic prefix, and wherein the step of determining an uplink timing estimate from the signal transmitted from the mobile device to the macrocell base station comprises determining an uplink symbol timing estimate by:
examining the signal transmitted from the mobile device and identifying repeated portions in the signal transmitted from the mobile device, the repeated portions being a cyclic prefix at the start of a symbol and a final portion of the symbol corresponding to the cyclic prefix; and
determining the uplink symbol timing estimate as the start of the identified cyclic prefix.

3. A method as claimed in claim 1, wherein determining a downlink timing estimate from the signal transmitted from the macrocell base station comprises determining a downlink symbol timing estimate from synchronization information contained in the signal.

4. A method as claimed in claim 1, the method further comprising:
determining an offset between uplink and downlink transmissions between the macrocell base station and the mobile device, wherein the timing estimate for use in synchronizing the femtocell base station to the macrocell base station is determined from at least one of the offset, the downlink timing estimate and the uplink timing estimate.

5. A method as claimed in claim 1, wherein the method in the femtocell base station further comprises:
identifying a mobile device that is being served by the macrocell base station and that is near to the femtocell base station, wherein the step of determining an uplink timing estimate comprises determining the uplink timing estimate from a signal transmitted to the macrocell base station by the identified mobile device.

6. A method as claimed in claim 5, wherein identifying a mobile device that is near to the femtocell base station comprises:
receiving signals at the femtocell base station transmitted by a mobile device that is being served by the macrocell base station;
comparing the strength of the signals received at the femtocell base station to a threshold; and
determining that the mobile device is close to the femtocell base station if the strength of the signals exceeds the threshold.

7. A method as claimed in claim 5, further comprising causing a mobile device that is being served by the femtocell base station to hand-off to the macrocell base station, and determining an uplink timing estimate comprises determining the uplink timing estimate from a signal transmitted to the macrocell base station by that mobile device.

8. A method as claimed in claim 1, wherein the timing estimate determined when determining a timing estimate for use in synchronizing the femtocell base station to the macrocell base station is an estimate of the propagation delay between the macrocell base station and the femtocell base station.

9. A method as claimed in claim 8, wherein the estimate of the propagation delay is determined from a difference between the downlink timing estimate and the uplink timing estimate.

10. A method as claimed in claim 1, wherein the timing estimate determined in the step of determining a timing estimate for use in synchronizing the femtocell base station to the macrocell base station is an estimate of the symbol timing at the macrocell base station.

11. A method as claimed in claim 10, wherein the estimate of the symbol timing at the macrocell base station is determined by (i) taking the average of the downlink timing estimate and the uplink timing estimate; (ii) estimating the propagation delay between the macrocell base station and the femtocell base station from the difference between the downlink timing estimate and the uplink timing estimate and subtracting the estimated propagation delay from the downlink timing estimate; or (iii) estimating the propagation delay between the macrocell base station and the femtocell base station from the difference between the downlink timing estimate and the uplink timing estimate and adding the estimated propagation delay to the uplink timing estimate.

12. The method as claimed in claim 1 further comprising synchronizing the femtocell base station to the macrocell base station by determining a timing estimate using the method as claimed in claim 1 and adjusting the timing of transmissions from the femtocell base station according to the determined timing estimate.

13. A femtocell base station for use in a communication network that includes at least one macrocell base station, the femtocell base station comprising:
a processor configured to execute computer-readable code;
a memory accessible by the processor, the memory storing non-transitory computer-readable code configured to:
determine an uplink timing estimate from a signal transmitted from a mobile device to the macrocell base station, the mobile device being served by the macrocell base station;
determine a downlink timing estimate from a signal transmitted from the macrocell base station; and
determine a timing estimate for use in synchronizing the femtocell base station to the macrocell base station from the downlink timing estimate and the uplink timing estimate.

14. A femtocell base station for use in a communication network comprising at least one macrocell base station, the femtocell base station comprising:
a processor configured to determine a timing estimate for use in synchronizing the femtocell base station to the macrocell base station by:
determining an uplink timing estimate from a signal transmitted from a mobile device to the macrocell base station, the mobile device being served by the macrocell base station;
determining a downlink timing estimate from a signal transmitted from the macrocell base station; and
determining a timing estimate for use in synchronizing the femtocell base station to the macrocell base station from the downlink timing estimate and the uplink timing estimate.

15. A femtocell base station as claimed in claim 14, wherein the signal transmitted from the mobile device to the macrocell base station comprises a plurality of symbols, each symbol having a cyclic prefix, and wherein the uplink timing estimate is an uplink symbol timing estimate, and the processor is configured to determine the uplink symbol timing estimate from the signal transmitted from the mobile device to the macrocell base station by:
examining the signal and identifying repeated portions in the signal, the repeated portions being a cyclic prefix at the start of a symbol and a final portion of the symbol corresponding to the cyclic prefix; and
determining the uplink symbol timing estimate as the start of the identified cyclic prefix.

16. A femtocell base station as claimed in claim 14, wherein the downlink timing estimate is a downlink symbol timing estimate, and the processor is configured to determine the downlink symbol timing estimate from synchronization information contained in the signal transmitted from the macrocell base station.

17. A femtocell base station as claimed in claim 14, wherein the processor is further configured to:
determine an offset between uplink and downlink transmissions between the macrocell base station and the mobile device, and
determine the timing estimate for use in synchronizing the femtocell base station to the macrocell base station from one or more of the offset, the downlink timing estimate and the uplink timing estimate.

18. A femtocell base station as claimed in claim 14, wherein the processor is further configured to:
identify a mobile device that is being served by the macrocell base station and that is near to the femtocell base station; and
determine the uplink timing estimate from a signal transmitted to the macrocell base station by the identified mobile device.

19. A femtocell base station as claimed in claim 18, wherein the processor is configured to identify a mobile device that is near to the femtocell base station by:
comparing the strength of signals received at the femtocell base station that have been transmitted by a mobile device served by the macrocell base station to a threshold; and
determining that the mobile device is close to the femtocell base station if the strength of the signals exceeds the threshold.

20. A femtocell base station as claimed in claim 18, wherein the processor is further configured to:
cause a mobile device that is being served by the femtocell base station to hand-off to the macrocell base station; and
determine the uplink timing estimate from a signal transmitted to the macrocell base station by that mobile device.

21.-25. (canceled)
